(19) United States
(12) Patent Application Publication
(10) Pub. No.: US 2004/0253560 A1
(43) Pub. Date: Dec. 16, 2004

(54) Apparatus and method of continuously producing a boiled and vacuumized confectionery mass

(76) Inventors: Klaus Markwardt, Laatzen (DE); Jens Fleisch, Wernigerode (DE); Zvonimir Versic, Hannover (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/867,233

(22) Filed: Jun. 14, 2004

(30) Foreign Application Priority Data
Jun. 13, 2003 (DE) 103 26 791.3

(51) Int. Cl. F27B 14/00; F27B 5/04; F25B 1/00

(52) U.S. Cl. 432/13; 432/205

(57) ABSTRACT

An apparatus (100, 100′, 100″) and a method serve to continuously produce a cooked and vacuumized confectionery mass. The apparatus (100, 100′, 100″) includes a boiling apparatus (3), an evaporating chamber (8), a conduit (7) connecting the boiling apparatus (3) to the evaporating chamber (8) and a pressure maintaining valve (9). The pressure maintaining valve (9) is arranged in the conduit (7) between the boiling apparatus (3) and the evaporating chamber (8). The pressure maintaining valve (9) serves to continuously maintain at least atmospheric pressure in the boiling apparatus (3) and negative pressure in the evaporating chamber (8). The method includes the steps of boiling an aqueous solution of substances under pressure which is at least atmospheric pressure, separating the aqueous solution of substances with respect to pressure, and evaporating the cooked solution of substances under negative pressure for at least a few seconds.

### CROSS REFERENCE TO RELATED APPLICATIONS

This application claims priority to co-pending German Patent Application No. 103 26 791.3 entitled “Verfahren und Vorrichtung zum kontinuierlichen Herstellen von gekochten und vakuumierten Süβwarenmassen”, filed Jun. 13, 2003.

### FIELD OF THE INVENTION

The present invention generally relates to a method of continuously producing boiled and vacuumized confectionery masses, especially candy masses, caramel masses, fondant masses, and the like. An aqueous solution of substances is boiled, evaporated and subjected to negative pressure. The present invention also relates to an apparatus for producing cooked and vacuumized confectionery masses including a boiling apparatus and an evaporating chamber.

The present invention especially relates to the continuous and automatic production of hard candy masses containing sugar or sugar substituting substances. An aqueous solution of substances is produced and processed. Then, downstream of a discharging apparatus, additional substances are added by means of a mixer, and they are mixed with the processed solution. In the following, the confectionery mass is further processed, especially it may be shaped to form candy, for example.

### BACKGROUND OF THE INVENTION

A method and an apparatus for continuously producing a boiled and vacuumized confectionery mass are known from German Patent Application No. DE 33 36 187 A1 corresponding to U.S. Pat. No. 4,666,730. The known boiling apparatus is designed as a spiral boiling apparatus the exit of which is connected to an evaporating chamber by a conduit. The boiled mass is evaporated in the evaporating chamber. Exhaust vapors are removed from the evaporating chamber by a vapor escape. A vacuum chamber is connected to the evaporating chamber, the mass being continuously sucked into the vacuum chamber. Re-evaporation and cooling of the mass resulting therefrom takes place in the vacuum chamber due to the low absolute pressure. Usual candy containing sugar, for example by using saccharose or glucose syrup, is produced. Boiling takes place in a spiral boiling apparatus, the hot solution reaching a temperature of approximately 140° C. The known method may result in dry substance of approximately 97%.

Another apparatus and method for continuously producing boiled and vacuumized confectionery masses are known from German Patent Application No. DE 40 19 916 A1 corresponding to European Patent No. EP 0 534 994 B1. The aqueous solution of substances is boiled in a boiling apparatus, and it is fed into an evaporating chamber via a conduit. The evaporating chamber includes a vapor escape being connected to the atmosphere. A vacuum chamber is located below the conical evaporating chamber. Passage of the mass from the evaporating chamber into the vacuum chamber is controlled by a needle valve. The vacuum chamber is connected to a source of negative pressure. In this way, the aqueous solution of substances is boiled under atmospheric pressure, and it is fed into the evaporating chamber in which also atmospheric pressure prevails directly by a conduit. In case substances containing sugar are used, the solution reaches the vacuum chamber via the opened needle valve. The solution is then further evaporated in the vacuum chamber, and there is a respective cooling effect. In the following, the mass is transported by a discharge apparatus for further processing. In case sugar substitute substances are used, a cooling apparatus including special scrapers is used. The cooling apparatus is arranged between the evaporating chamber and the vacuum chamber such that the period of time during which the mass is processed is prolonged. The same negative pressure prevails in the cooling apparatus and in the vacuum chamber.

A method of continuously producing hard candy masses from an aqueous solution of substances is known from German Patent No. DE 38 21 505 C2 corresponding to U.S. Pat. No. 5,167,981. Sugar substitute substances are used. The viscosities of the sugar substitute substances are below the ones of saccharose and glucose syrup masses when comparing at the same temperatures and the same dry substance percentage. This sugar free solution is boiled under the influence of negative pressure in a spiral boiling apparatus. The exit of the boiling apparatus is simply connected to the entrance of an evaporating chamber located downstream by a conduit. The boiled solution is evaporated in the evaporating chamber under the influence of negative pressure which is not more than 0.3 bar absolute. This negative pressure does not only have an effect in the evaporating chamber locating downstream, but it also prevails in the spiral of the spiral boiling apparatus, the negative pressure reducing along the length of this conduit. In this way, the boiling process takes place under continuous pressure decrease as seen in the streaming direction through the boiling apparatus until it reaches the negative pressure in the evaporating chamber. Due to this decrease of pressure, especially high boiling temperatures of the solution are prevented which may be advantageous for different cases. However, due to the use of negative pressure already in the boiling apparatus, one achieves a very large steam volume. Consequently, the usable heat transfer surface of the boiling apparatus is reduced in a disadvantageous way. Thus, the boiling apparatus has to be designed to have greater dimensions.

### SUMMARY OF THE INVENTION

The present invention relates to an apparatus for continuously producing a cooked and vacuumized confectionery mass. The apparatus includes a boiling apparatus, an evaporating chamber, a conduit being designed and arranged to connect the boiling apparatus to the evaporating chamber and a pressure maintaining valve. The pressure maintaining valve is arranged in the conduit between the boiling apparatus and the evaporating chamber. The pressure maintaining valve is designed and arranged to continuously maintain at least atmospheric pressure in the boiling apparatus and negative pressure in the evaporating chamber.

The present invention also relates to a method of automatically and continuously producing a cooked and vacuumized confectionery mass. The method includes the steps of boiling an aqueous solution of substances under pressure which i, at least atmospheric pressure, separating the aqueous solution of substances with respect to pressure, and evaporating the cooked solution of substances under negative pressure for at least a few seconds.

The term “at least atmospheric pressure” is to be understood as relating to pressure having the same value as the atmosphere or a higher value. The term “negative pressure” is to be understood as relating to pressure having a value which is less than the pressure value of the atmosphere. With the novel apparatus and method for continuously producing and processing boiled and vacuumized confectionery masses, it is possible to achieve confectionery masses having a low remaining percentage of water of especially less than 1.5%.

Boiling of the aqueous solution of substances is realized in a way such that it is separated from the evaporating process concerning pressure conditions. For this purpose, there is a pressure separation means arranged between the boiling apparatus and the evaporating chamber. The pressure separation means may especially be designed as a pressure maintaining valve. The pressure separation means makes it possible to continuously maintain different pressure upstream of the pressure separation without having a negative influence on the continuous flow of the confectionery mass. In this way, atmospheric pressure or some positive pressure may be used in the boiling apparatus, whereas evaporation takes place under the influence of negative pressure (depression, sub-atmospheric pressure). Cooking under atmospheric pressure or low positive pressure ensures that the heat transmitting surface of the boiling apparatus is used in an optimum way since the resulting steam volume is comparatively small. The boiling apparatus may be designed as a heat exchanger, a spiral boiling apparatus, a rotor boiling apparatus and the like, for example. After having passed the pressure separation, the cooked solution gets under the influence of negative pressure. It is known from the prior art to apply the negative pressure treatment for a comparatively short period of time. Consequently, in prior art methods, the mass is under the influence of negative pressure for approximately two seconds before the mass is discharged by means of the discharging apparatus. The novel method and apparatus intend to use a residing time during which the mass is under the influence of negative pressure of at least a few seconds. Preferably, the residing time is substantially longer than it is known from the prior art. For example, the residing time may be longer than 5 seconds, preferably 10 seconds or even 15 seconds or more. Such a prolonged residing time has the goal of reaching great percentages of dry substance which may be even more than 99%. For transporting the mass which is under the influence of negative pressure during evaporation with the discharging apparatus, sufficient viscosity of the mass is required. This viscosity is reached due to intensive evaporation and cooling of the mass resulting therefrom upstream of the discharging apparatus. It is preferred not to use additional cooling units at this place.

Evaporation may be realized in one step. However, it is preferred to use two steps. Preferably, negative pressure of less than approximately 0.6 bar absolute is used in the first step, and negative pressure of less than approximately 0.15 bar absolute is used in the second step. Especially, it is possible to control the method in a way that it uses negative pressure of 0.08 bar absolute in the first step and negative pressure of 0.05 bar absolute in the second step such that a percentage of dry substance of more than 99% is reached.

Maintaining a different pressure in the boiling apparatus compared to the evaporating chamber by a pressure separation may especially be realized by arranging a pressure maintaining valve in the conduit interconnecting the boiling apparatus and the evaporating chamber. Such a pressure maintaining valve makes it possible to maintain pressure in the boiling apparatus which is higher than the pressure prevailing in the evaporating chamber. The required period of time for boiling is shortened in an advantageous way, while the residing time of the solution and of the mass, respectively, in the evaporating chamber is increased compared to the prior art. The residing time under evaporating conditions may be prolonged to at least a few seconds, especially more than 5 seconds, preferably more than approximately 10 seconds. For this purpose, the portion or section of the conduit between the pressure maintaining valve and the evaporating chamber may be designed to have an enlarged cross section and to be comparatively long and/or the portion may be increased by using an additional residing container. However, it is not desired to buffer or settle the solution and the mass, respectively, in these cross sections. It is desired to maintain continuous flow of the mass at all places such that the mass always moves. In this way, it is also ensured that the ratio of additives and basic mass remains constant during processing. For example, this may be of special importance to the production of medical candy. The solution and the mass, respectively, preferably move through the evaporating chamber in a continuous and uniform manner.

The evaporating chamber may also include a first and a second negative pressure chamber, the negative pressure chambers being interconnected by an adjustable needle valve. The needle valve allows for variation and adjustment of an annular cross section through which the solution passes from the first negative pressure chamber into the second negative pressure chamber. Usually, this is realized by the first negative pressure chamber being located above the second negative pressure chamber and under the influence of gravity, the difference of the two negative pressures being additionally used for transport.

The evaporating chamber and the evaporating chambers, respectively, including the portion of the conduit downstream of the pressure maintaining valve are advantageously designed to include two walls the gap between which is connected to a tempering circuit through which tempering medium flows. The tempering circuit serves to maintain the desired temperatures in the entire evaporating chamber. The same concept applies to the additional residing container.

In case of a design in which evaporation takes place in two steps, the first negative pressure chamber may be connected to a first negative pressure generator and the second negative pressure chamber may be connected to a second separate negative pressure generator. This arrangement makes sense since different negative pressures are active. However, it is also possible to derive the different negative pressures from a common pressure generator, for example a pump.

In case of evaporating in two steps, the two negative pressure chambers may be designed and arranged such that the residing time of the boiled solution in the first negative pressure chamber corresponds approximately to a quadruple of the residing time in the second negative pressure chamber. In this way, the residing time in the first negative pressure chamber may be approximately 8 seconds, and the residing time in the second negative pressure chamber may be approximately 2 seconds.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic view of an exemplary embodiment of the novel apparatus for continuously producing a boiled and vacuumized confectionery mass including two evaporating steps.

FIG. 2 is a schematic view an exemplary embodiment of the novel apparatus for continuously producing a boiled and vacuumized confectionery mass including one evaporating step.

FIG. 3 is a view of a boiling point diagram.

FIG. 4 is a view of a boiling point diagram comparing the novel method to the prior art.

FIG. 5 is a schematic view of a system which may be easily changed from processing confectionery mass containing sugar to confectionery mass not containing sugar.

### DETAILED DESCRIPTION

Referring now in greater detail to the drawings, FIG. I illustrates the most important elements of a novel apparatus 100 for continuously producing a boiled and vacuumized confectionery mass. It is to be understood that the ingredients (substances) are first weighed and then solved in water as it corresponds to the recipe of the respective aqueous solution to be processed for attaining a confectionary mass. The aqueous solution is fed to a boiling apparatus 3 via a conduit 1 by a pump 2 being driven by a motor M. The boiling apparatus 3 may be designed as a spiral boiling apparatus. A conduit 4 extends through the boiling apparatus 3, steam being fed through the conduit 4. The respective condensate 5 is removed at the exit of the boiling apparatus 3.

The boiling apparatus 3 includes another exit 6 from which a conduit 7 leads to an evaporating chamber 8. A pressure sensor PI and a temperature sensor TI are arranged in the conduit 7. A pressure maintaining valve 9 is located in the conduit 7. The conduit 7 leading to the evaporating chamber 8 includes a section 10 downstream of the pressure maintaining valve 9, the section 10 being designed to have a comparatively great cross section and to be comparatively long. The cooked solution is transported into the evaporating chamber 8 through the section 10 such that the period of time during which the solution resides in the evaporating chamber 8 including the section 10 is at least a few seconds, especially approximately between 8 to 10 seconds.

The evaporating chamber 8 is formed by a container 11 which may be designed to be round and to include a vertical axis. The interior of the container 11 includes two negative pressure chambers 13 and 14 being located one above the other and being separated by a conical wall 12. A needle valve 15 being designed to be adjustable by a motor M is arranged between the negative pressure chambers 13 and 14. The needle valve 15 cooperates with the conical wall 12, and it is designed in a way that its annular cross section is adjustable by the motor M. The negative pressure chamber 13 is connected to a negative pressure generator 16, exhaust vapours exiting through a conduit 17. It is to be understood that negative pressure (meaning pressure below atmospheric pressure) produced by the first negative pressure generator 16 does not only directly have an effect in the first negative pressure chamber 13 in the container 11, but also in the section 10 of the conduit 7 being located upstream. Due to the increased residing time of the solution and of the confectionery mass, respectively, in the negative pressure chamber 13, substantial evaporation takes place. It may be advantageous to use a negative pressure of less than approximately 0.6 bar absolute.

Correspondingly, the second negative pressure chamber 14 is connected to a conduit 18 in which a second negative pressure generator 19 is arranged. In this way, there is the possibility of using negative pressure of less than approximately 0.15 bar absolute in this second step. A discharging apparatus 20 is located at the lower end of the container 11 and of the negative pressure chamber 14, respectively. The discharging apparatus 20 includes a conveying screw 21 being driven by a motor M. The conveying screw 21 of the discharging apparatus 20 is operated in a way that the gaps or channels between the convolutions of the conveying screw 21 are filled with confectionery mass. In this way, the second negative pressure chamber 14 is closed with respect to pressure. A conduit 22 leads from the exit of the discharging apparatus 20 to a mixer and further on to usual processing apparatuses, for example for shaping candy.

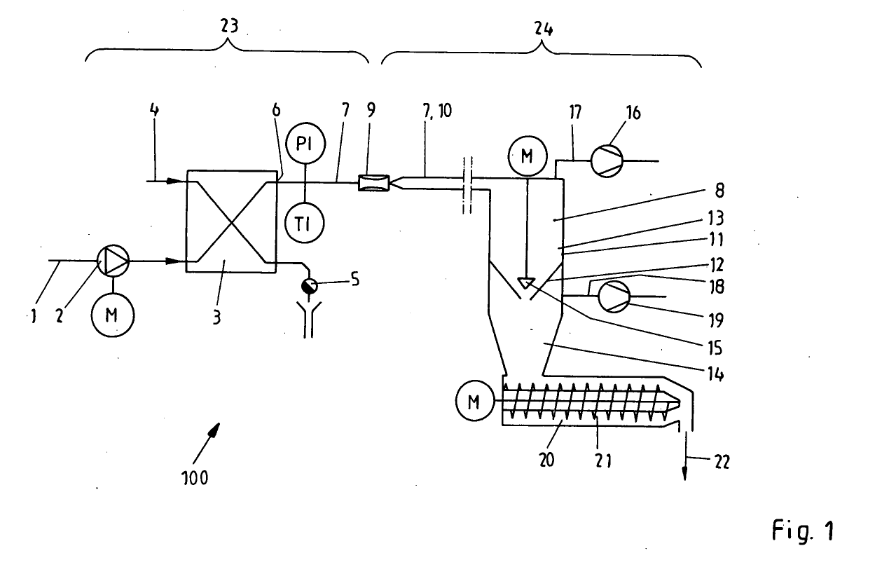

FIG. 1 illustrates two portions of the apparatus 100 of which one is located upstream of the pressure maintaining valve 9, and the other one is located downstream of the pressure maintaining valve 9. There is no negative pressure in the first portion 23. There is negative pressure in the second portion 24.

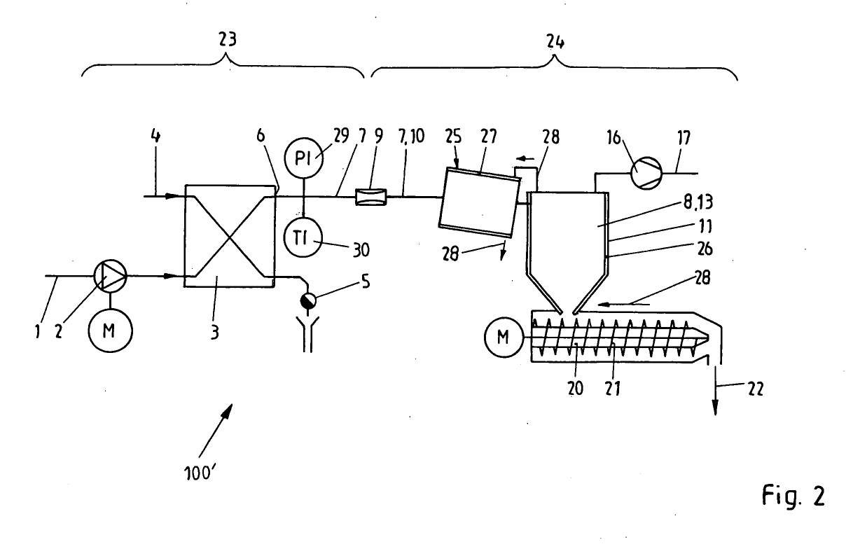

FIG. 2 schematically illustrates an apparatus 100′ in which evaporation takes place in only one step. The apparatus 100′ has a lot in common with the apparatus 100 according to FIG. 1. Consequently, it is herewith referred to the description with respect to FIG. 1. In contrast to the embodiment of the apparatus 100 according to FIG. 1, the apparatus 100′ includes the container 11 only including one single evaporating chamber 8. The evaporating chamber 8 is only designed to be the only negative pressure chamber 13. There is no need for arranging a needle valve. The discharging apparatus 20 is directly located at the exit of the negative pressure chamber 13. An intermediate container 25 is located in the section 10 of the conduit 7. The intermediate container 25 substantially has the goal of prolonging the residing time of the cooked solution. The intermediate container 25 may be arranged in an inclined way to ensure continuous flow of the mass. The remaining elements of the section 10 of the conduit 7 upstream and downstream of the intermediate container 25 may be designed as conduits having a comparatively small cross section or as comparatively long conduits having a comparatively great cross section as illustrated in FIG. 1. The container 11 as well as the intermediate container 25 and possibly the long section 10 having a great cross section of the conduit 7 may be design to include a double-walled housing the gaps 26 and 27 of which are connected to a tempering circuit 28. A pressure sensor 29 and a temperature sensor 30 may be arranged at the exit 6 of the boiling apparatus 3 or in the section of the conduit 7 upstream of the pressure maintaining valve 9. A boiling temperature of approximately 145° C. or more is used in the boiling apparatus 3. The use of different boiling temperatures depends on the kind and the properties of the confectionery mass to be produced.

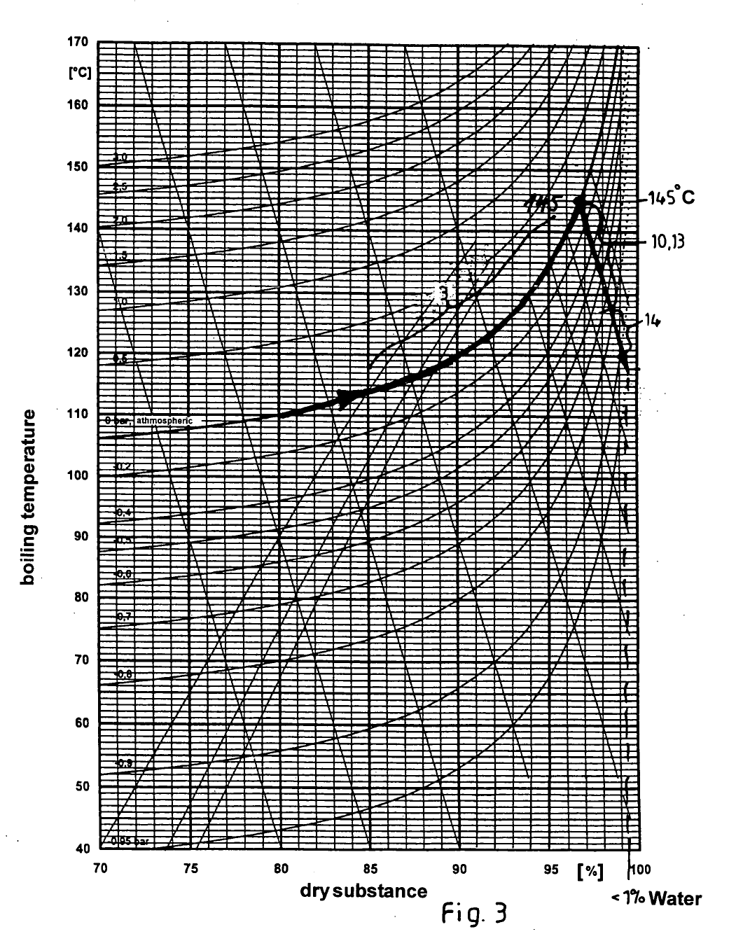

FIG. 3 illustrates a boiling point diagram illustrating the boiling temperature on the vertical axis and the percentage of the dry substance on the horizontal axis. FIG. 3 illustrates a boiling line, as it may be for example achieved with the apparatus 100 according to FIG. 1. An aqueous solution of ingredients with 80% of dry substance—in other words an aqueous solution of 20%—is the starting point of the boiling curve. For example, the solution is boiled on the line of atmospheric pressure. This means that an increase of temperature takes place in the boiling apparatus 3 along this pressure line to reach a temperature of approximately 145° C. The cooked confectionery mass is then evaporated in a first step in the first negative pressure chamber 10, 13. This results in approximately 98.5% of dry substance. In the following second step, the mass is further evaporated and cooled in the second negative pressure chamber 14 such that one attains more than 99% of dry substance, meaning less than 1% of water. At the same time, the mass is cooled such that the mass has a temperature of approximately 118° C. at the entrance of the discharging apparatus.

In case the mass is boiled in the boiling apparatus 3 under the influence of positive pressure, the beginning of the process line is located at a comparatively higher level. This may usually also lead to higher boiling temperatures. A second evaporating step follows in a respective way.

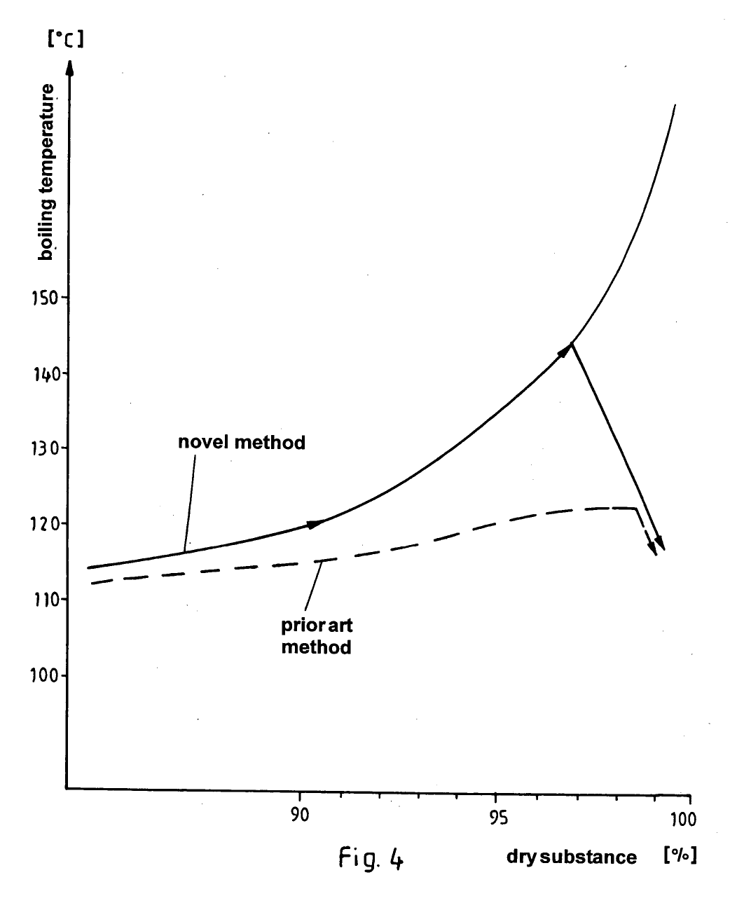

FIG. 4 schematically illustrates the difference between the novel method and the prior art method. The boiling curve according to the novel method is illustrated by a continuous line. The boiling curve according to the prior art method is illustrated by a broken line. The respective increasing portions of the lines illustrate the conditions in the cooking apparatus. The decreasing portions of the lines illustrate the conditions during the evaporating step.

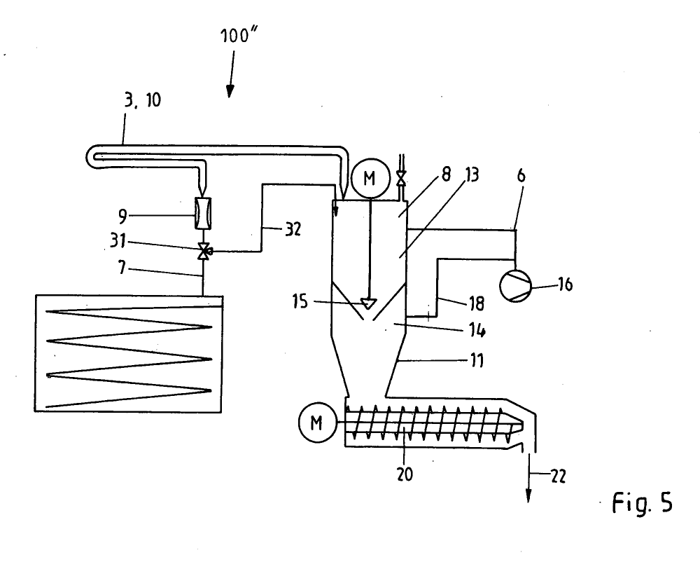

The exemplary embodiments of the novel apparatus 100, 100′ are especially advantageous for continuously producing confectionery masses not containing sugar. FIG. 5 illustrates another exemplary embodiment of the novel apparatus 100″ which may be easily modified to change from the production of sugar free confectionery masses to the production of confectionery masses including saccharose and glucose syrup. For this purpose, a three-ways valve 31 is located in the conduit 7 upstream of the pressure maintaining valve 9. The section 10 of the conduit 7 between the pressure maintaining valve 9 and the entrance of the container 11 is designed to have a great cross section and to be comparatively long. A conduit 32 is located between the three-ways valve 31 and the entrance of the container 11. By switching the three-ways valve 31, confectionery mass is fed into the container 11 via the section 10 when processing sugar free masses. When producing confectionery masses containing sugar, the conduit 32 is used instead.

Many variations and modifications may be made to the preferred embodiments of the invention without departing substantially from the spirit and principles of the invention. All such modifications and variations are intended to be included herein within the scope of the present invention, as defined by the following claims.

We claim:

1. An apparatus for continuously producing a cooked and vacuumized confectionery mass, comprising:
a boiling apparatus;
an evaporating chamber;
a conduit, said conduit being designed and arranged to connect said boiling apparatus to said evaporating chamber; and
a pressure maintaining valve, said pressure maintaining valve being arranged in said conduit between said boiling apparatus and said evaporating chamber, said pressure maintaining valve being designed and arranged to continuously maintain at least atmospheric pressure in said boiling apparatus and negative pressure in said evaporating chamber.

2. The apparatus of claim 1, wherein said conduit includes a section being designed to have an enlarged cross section and to be comparatively long to increase the period of time during which the confectionery mass is evaporated to at least a few seconds.

3. The apparatus of daim 1, further comprising a residing container, said residing container being arranged in said conduit and being designed and arranged to increase the period of time during which the confectionery mass is evaporated to at least a few seconds.

4. The apparatus of claim 1, wherein said evaporating chamber includes a first negative pressure chamber, a second negative pressure chamber and an adjustable needle valve, said first and second negative pressure chambers being interconnected by said adjustable needle valve.

5. The apparatus of claim 4, wherein said needle valve is designed to be adjustable in a way that the pressure in said first negative pressure chamber is less than approximately 0.6 bar and the pressure in said second negative pressure chamber is less than approximately 0.15 bar.

6. The apparatus of claim 1, further comprising a tempering circuit, said evaporating chamber being designed to be double-walled and said evaporating chamber being connected to said tempering circuit.

7. The apparatus of claim 3, further comprising a tempering circuit, said residing container being designed to be double-walled and said residing container being connected to said tempering circuit.

8. The apparatus of claim 4, further comprising a first negative pressure generator and a second negative pressure generator, said first negative pressure chamber being connected to said first negative pressure generator and said second negative pressure chamber being connected to said second negative pressure generator.

9. The apparatus of claim 8, wherein said first and second negative pressure chambers are designed and arranged in a way that the period of time during which the cooked confectionery mass is located in said first negative pressure chamber is approximately a quadruple of the period of time during which the confectionery mass is located in said second negative pressure chamber.

10. A method of automatically and continuously producing a cooked and vacuumized confectionery mass, comprising the steps of:
boiling an aqueous solution of substances under pressure which is at least atmospheric pressure;
separating the aqueous solution of substances with respect to pressure; and
evaporating the cooked solution of substances under negative pressure for at least a few seconds.

11. The method of claim 10, wherein the cooked solution of substances is evaporated for at least 5 seconds.

12. The method of claim 10, wherein the cooked solution of substances is evaporated for at least 10 seconds.

13. The method of daim 10, wherein the evaporating step includes a first evaporating step and a second evaporating step, the negative pressure under which the cooked solution of substances is evaporated in the first evaporating step being less than approximately 0.6 bar and the negative pressure under which the cooked solution of substances is evaporated in the second evaporating step being less approximately 0.15 bar.

14. The method of claim 11, wherein the evaporating step includes a first evaporating step and a second evaporating step, the negative pressure under which the cooked solution of substances is evaporated in the first evaporating step being less than approximately 0.6 bar and the negative pressure under which the cooked solution of substances is evaporated in the second evaporating step being less approximately 0.15 bar.

15. The method of claim 10, wherein the confectionery mass is selected from the group consisting of candy mass, caramel mass and fondant mass.
